(19) United States
(12) Patent Application Publication
(10) Pub. No.: US 2025/0028512 A1
(43) Pub. Date: Jan. 23, 2025

(54) INFORMATION PROCESSING DEVICE AND IMAGE FORMING DEVICE

(71) Applicant: TOSHIBA TEC KABUSHIKI KAISHA, Tokyo (JP)

(72) Inventor: Shigeo UCHIDA, Mishima Shizuoka (JP)

(73) Assignee: TOSHIBA TEC KABUSHIKI KAISHA, Tokyo (JP)

(21) Appl. No.: 18/641,071

(22) Filed: Apr. 19, 2024

(30) Foreign Application Priority Data
Jul. 20, 2023 (JP) 2023-118538

(51) Int. Cl. G06F 8/61; H04N 1/00

(52) U.S. Cl. CPC G06F 8/61; H04N 1/00938

(57) ABSTRACT

According to one embodiment, the information processing device includes a storage and a processor. The storage is configured to store application programs provided with a probational period. The processor is configured to stop a first-time automatic startup of the application program provided with the probational period during a startup of the information processing device.

### CROSS-REFERENCE TO RELATED APPLICATION

This application is based upon and claims the benefit of priority from Japanese Patent Application No. 2023-118538, filed on Jul. 20, 2023, the entire contents of which are incorporated herein by reference.

### FIELD

Embodiments described herein relate generally to information processing devices and image forming devices.

### BACKGROUND

In image forming devices, such as digital multifunction peripherals, firmware bundled with an application program (hereinafter referred to as application) may be installed during a manufacturing process. The firmware installed during the manufacturing process is called, for example, SYSROM. There are two types of applications provided in the SYSROM: types that are started up by a user operation (e.g., the manual startup, etc.) and types that are started up without the user operation (e.g., the automatic startup, etc.). Further, in some applications bundled with SYSROM, a trial period (e.g., a probational period, etc.) during which the applications can be used free of charge will be set. When the application with the trial period set is started up for the first time, a trial license is generated, and countdown for the trial (e.g., test period, etc.) period is started.

On the other hand, the information processing devices such as digital multifunction peripherals are sometimes provided to users after being set up by a worker with specialized knowledge after manufacturing. During setup by the worker, the application bundled with the SYSROM is installed in the device, and an application with automatic startup is started up. For this reason, when the trial period is set, the application with the automatic startup issues the trial license for the setup by the operator. In such a case, there is a problem in that the trial period of the application is substantially shortened due to a time lag between the setup by the worker and the user starting of use.

### DESCRIPTION OF THE DRAWINGS

FIG. 1 is a diagram illustrating an image forming device as an information processing device according to an embodiment.

FIG. 2 is a diagram illustrating an example of process of providing the image forming device as an information processing device to a user;

FIG. 3 is a flowchart illustrating an operation example of firmware installation on the image forming device;

FIG. 4 is a flowchart illustrating an operation of installing an application in a normal startup mode after unpacking in the image forming device according to one embodiment;

FIG. 5 is a diagram illustrating an example of management information for the image forming device to manage applications according to one embodiment;

FIG. 6 is a flowchart illustrating an operation of checking a startup setting of the application in the image forming device according to one embodiment; and

FIG. 7 is a flowchart illustrating an operation of starting up the application set to be manually started up in the image forming device according to one embodiment.

### DETAILED DESCRIPTION

In order to solve the above-mentioned problems, an information processing device and an image forming device that can suppress startup of applications provided with a probational period are to be provided.

In general, according to one embodiment, an information processing device includes a storage unit and a processor. The storage unit (e.g., a storage, a memory, etc.) stores application programs provided with a probational period. The processor stops a first-time automatic startup of the application program provided with the probational period accompanying a startup of the information processing device.

Embodiments will be described below with reference to the drawings.

In the following embodiments, a digital multifunction peripheral (MFP), which is an example of an image forming device as an information processing device, will be described.

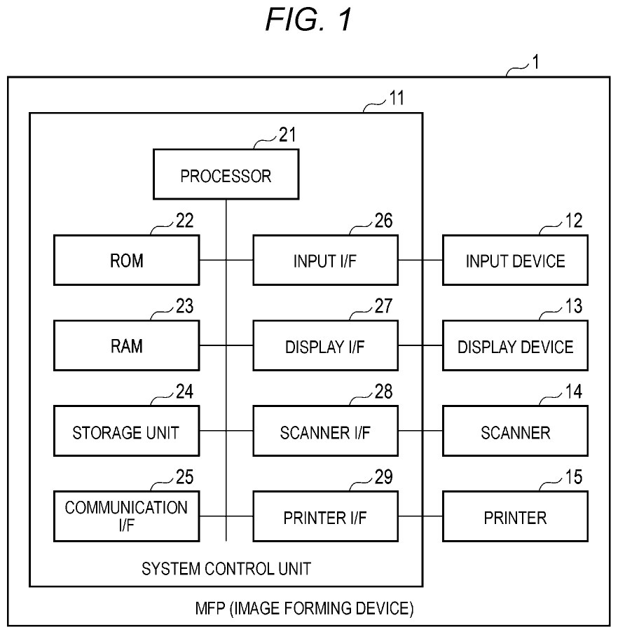

FIG. 1 is a block diagram illustrating a configuration example of a digital multifunction peripheral 1 as an information processing device according to the embodiment.

As illustrated in FIG. 1, the digital multifunction peripheral 1 includes a system control unit (e.g., a controller, etc.) 11, an input device (e.g., an inputter, input terminal, etc.)12, a display device (e.g., a display, a screen, etc.) 13, a scanner 14, a printer 15, and the like.

The input device 12 is a device for inputting operation instructions and the like. The input device 12 supplies a signal indicating the input instruction content to the system control unit 11.

The display device 13 is a device that displays images. The display device 13 displays images in response to instructions from the system control unit 11. The input device 12 and the display device 13 are configured with, for example, a display device attached with a touch panel. Some embodiments may include a touch screen display.

The scanner 14 scans a document placed on a document table and acquires an image of the document. For example, the scanner 14 includes a light emitting body and a photoelectric conversion device. The light emitting body emits light toward the surface of the document placed on the document table. The photoelectric conversion device includes a light receiving element (such as a CCD image sensor, etc.) that receives light from the surface of the document and converts the light into electronic data.

The printer 15 is an image forming device that forms an image on a sheet as a recording medium. The printer 15 forms the image on the sheet according to instructions from the system control unit 11. The image forming method of the printer 15 is not limited to a specific method, and may be an electrophotographic method, an inkjet method, or a thermal transfer method.

The system control unit 11 executes various information processing and comprehensively controls operations of each unit. In the configuration example illustrated in FIG. 1, the system control unit 11 includes a processor 21, a ROM 22, a RAM 23, a storage unit (e.g., a storage, a memory, etc.) 24, a communication interface (I/F) 25, an input interface (I/F) 26, a display interface (I/F) 27, a scanner I/F 28, a printer I/F 29, and the like.

The processor 21 executes various information processing and comprehensively controls the operations of each unit. The processor 21 is, for example, a central processing unit (CPU) or a micro processing unit (MPU). The processor 21 implements various processes by executing programs stored in the ROM 22 or the storage unit 24.

The ROM 22 is a nonvolatile memory. The ROM 22 stores programs for the system control unit 11 of the digital multifunction peripheral 1 to operate as an information processing device. The RAM 23 is a volatile memory. The RAM 23 functions as a working memory that temporarily stores data. The ROM 22 stores firmware that operates on an operating system (OS).

Data is written into the ROM 22 during the manufacturing process of the digital multifunction peripheral 1 at the manufacturing factory or the like. In this embodiment, it is assumed that the ROM 22 stores firmware bundled with an application program (hereinafter referred to as an application) during the manufacturing process of the digital multifunction peripheral 1. Further, the application bundled in the firmware stored in the ROM 22 is installed in the storage unit 24 during normal startup after unpacking setup, which will be described later.

The storage unit 24 is a rewritable nonvolatile memory. The storage unit 24 is configured with a storage device such as a hard disk drive (HDD) or a solid state drive (SSD). The storage unit 24 stores various data. For example, the storage unit 24 stores application programs installed by the operation of the processor 21. The storage unit 24 also stores management information of application programs.

The communication interface 25 is an interface for communicating with external devices. For example, the processor 21 may output image data obtained through processes to be described later to the external device via the communication interface 25.

The input interface 26 is an interface for connecting the input device 12. The display interface 27 is an interface for connecting the display device 13. The scanner interface 28 is an interface for connecting the scanner 14. The printer interface 29 is an interface for connecting the printer 15.

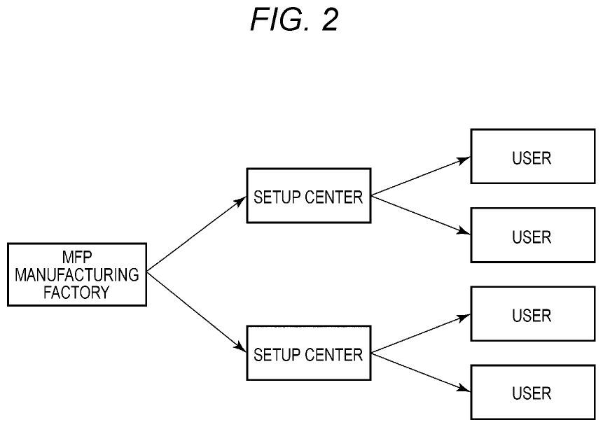

FIG. 2 is a diagram illustrating an example of processes until the digital multifunction peripheral 1 as an information processing device according to the embodiment is provided (e.g., delivered, received by, etc.) to a user.

The digital multifunction peripheral 1 is an information processing device that requires setup by the worker with specialized knowledge after manufacturing. In the example illustrated in FIG. 2, the digital multifunction peripheral 1 is manufactured according to specifications designated in advance at the manufacturing factory. For example, the digital multifunction peripheral 1 installs firmware bundled with the application in the ROM as a system memory during the manufacturing process. After the digital multifunction peripheral 1 is manufactured at the manufacturing factory, the digital multifunction peripheral is packed and transported to the setup center installed in a shipping destination area, or the like.

The digital multifunction peripheral 1 is set up (e.g., an unpacking setup, etc.) before being delivered to the user at the setup center by the worker with specialized knowledge. The unpacking setup is performed by the worker with specialized knowledge rather than by the actual user. After the digital multifunction peripheral 1 is completely unpacked setup, digital multifunction peripheral is transported from the setup center to the user and installed at the installation location designated by the user.

It is noted that the unpacking setup is not limited to being performed at a setup center. The unpacking setup may be performed at any time before the user starts using the digital multifunction peripheral 1. The digital multifunction peripheral 1 as an information processing device is premised on the assumption that there will be a time lag between when the unpacking setup is ended and when the user actually starts using the digital multifunction peripheral. In the embodiment described below, it is assumed that the user is provided with the digital multifunction peripheral 1 that is unpacked setup by the worker with specialized knowledge at the setup center.

Next, the description will be made of the operation of installing firmware bundled with the application, in the manufacturing process, in the digital multifunction peripheral 1 as an information processing device according to the embodiment.

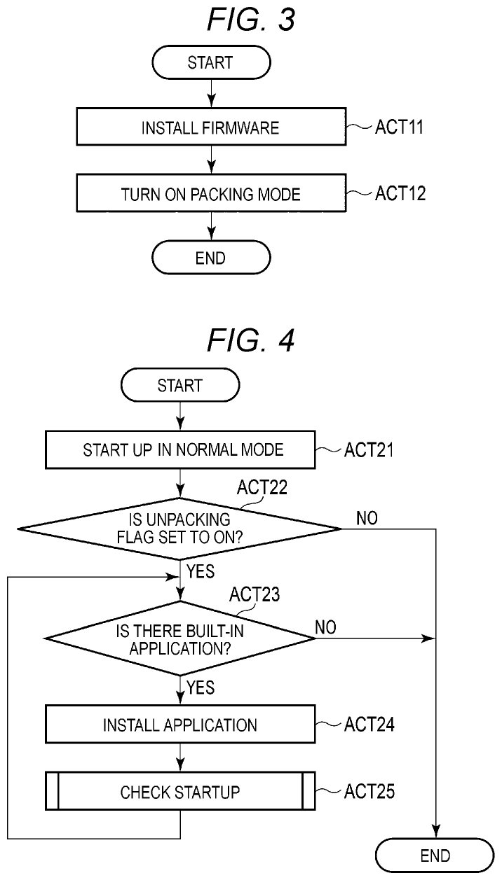

FIG. 3 is a flowchart illustrating an operation example for installing firmware bundled with the application in the digital multifunction peripheral 1 as an information processing device according to the embodiment.

In the digital multifunction peripheral 1, firmware bundled with the application is installed in a system memory such as the ROM 22 during the manufacturing process at a manufacturing factory (ACT11). For example, the firmware bundled with the data files of the application is written into the ROM 22 mounted in the system control unit 11 of the digital multifunction peripheral 1. Herein, the data file of the application stores data for installing the application in the storage device such as the storage unit 24.

When the firmware bundled with the application is installed in the digital multifunction peripheral 1, the packing mode indicating that the digital multifunction peripheral 1 is in the state where the digital multifunction peripheral is packed for shipment is turned on, and the unpacking flag is set on (ACT12). For example, the processor 21 of the system control unit 11 in the digital multifunction peripheral 1 turns on the packing mode and sets the unpacking flag in the storage unit 24 to on. In this state, the digital multifunction peripheral 1 is packed. Accordingly, the digital multifunction peripheral 1 in which the firmware bundled with the application is installed is transported to the setup center with the packing mode turned on and the unpacking flag set on.

Next, the installation operation of the application in the normal startup mode after the unpacking in the digital multifunction peripheral 1 as an information processing device according to the embodiment will be described.

FIG. 4 is a flowchart illustrating an operation example of installing the application in the normal startup mode after the unpacking in the digital multifunction peripheral 1 according to the embodiment.

The digital multifunction peripheral 1 manufactured at the manufacturing factory is delivered to the setup center with firmware installed, the packaging mode on, and the unpacking flag set on. When the unpacked digital multifunction peripheral 1 is started up at the setup center, the processor 21 of the digital multifunction peripheral 1 starts up in the packing mode and executes the unpacking setup.

When the unpacking setup is ended, the packing mode is turned off, and the digital multifunction peripheral 1 starts up in the normal startup mode (normal startup) (ACT21). In the case of the normal startup, the processor 21 of the digital multifunction peripheral 1 determines whether or not the processor is in the normal startup mode and the unpacking flag is set to on (ACT22). When the processor 21 is in the normal startup mode and the unpacking flag is on, the processor installs the application (built-in application) bundled in the firmware.

When the processor 21 is in the normal startup mode and the unpacking flag is on (ACT22, YES), the processor 21 determines whether or not there is a built-in application to be installed (e.g., that need to be installed, are waiting to be installed, etc.) bundled in the firmware (ACT23). When there is the built-in application to be installed, the processor 21 then installs the built-in application (ACT24). For example, the processor 21 extracts the data file of the built-in application bundled in the firmware. The processor 21 installs the application program into the storage unit 24 based on the data stored in the data file of the built-in application.

Furthermore, when installing the built-in application, the processor 21 stores the management information of the application in the storage unit 24. The management information of the application is information for managing setting information of the application, the operating state of the application, and the like. The management information of the application can be confirmed by the user through the user interface or the like.

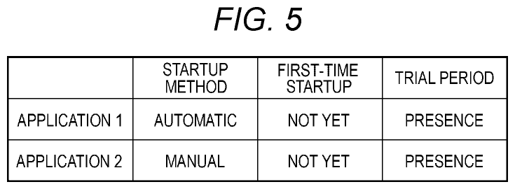

FIG. 5 is a diagram illustrating an example of management information for the image forming device according to the embodiment to manage applications.

In the example illustrated in FIG. 5, the management information of the applications includes information indicating “startup method”, “first-time startup”, “trial period”, and the like.

The “startup method” is information indicating a startup method of the application. For example, the “startup method” indicates the automatic startup of automatically being started up accompanying the startup (e.g., startup of the system, etc.) of the digital multifunction peripheral 1 or the manual startup of being started up in response to the operation instruction by the user. An application in which the startup method is set to be the automatic startup is started up automatically when the digital multifunction peripheral 1 is started up, even without the startup instruction by the user. Further, the application in which the startup method is set to be the manual startup is started up by the startup instruction (e.g., provided, etc.) by the user.

The “first-time startup” is information indicating whether or not the first-time startup of the application has been performed. For example, the application of which first-time startup is “not yet” indicates that the first-time startup is not executed (e.g., has not yet been executed, etc.). The management information of the application is not only information indicating whether or not first-time startup is not performed but also information including the number of times a startup is performed and may be stored (e.g., managed, etc.).

The “trial period” is information indicating whether or not the probational period (e.g., trial period, etc.) is provided to the application. As management information of the application, information indicating not only the presence or absence of the trial license but also the period provided as the trial (e.g., probational, etc.) period may be stored (e.g., managed, etc.).

When the installation of one built-in application is ended, the processor 21 executes a startup check process for the installed application (ACT25). In the startup check process, the processor 21 executes a process to suppress a first-time startup of the application provided with the trial period (e.g., probational period, etc.). For example, the processor 21 changes the startup method of the trial application from the automatic startup to the manual startup in response to the user operation. The startup check process will be described in detail later.

When the startup check process for the installed application is ended, the processor 21 returns to ACT23, and checks whether or not there are any built-in application to be installed. When there is at least one built-in application to be installed (ACT23, YES), the processor 21 proceeds to ACT24 and executes the above-described process again. Furthermore, when there is no built-in application to be installed (ACT23, NO), the processor 21 ends the installation of the built-in application during the normal startup after the unpacking setup.

Through the above-described process, the application bundled in the firmware is installed in the digital multifunction peripheral 1 during the normal startup after the unpacking setup. Further, according to the above-described operation example, the digital multifunction peripheral 1 executes the startup check process for the installed application during the normal startup after the unpacking setup. Accordingly, the digital multifunction peripheral 1 can suppress the first-time startup of the application (e.g., a trial application, etc.) for which the trial period is set by the startup check process for the installed application.

It is noted that the above-described operation example of the normal startup after the unpacking setup describes the installation of the built-in application and the startup check process. However, the digital multifunction peripheral 1 may execute processes other than the installation of built-in applications and the startup check process during the normal startup after the unpacking setup.

Next, the startup check process for the application in the digital multifunction peripheral 1 as an information processing device according to the embodiment will be described.

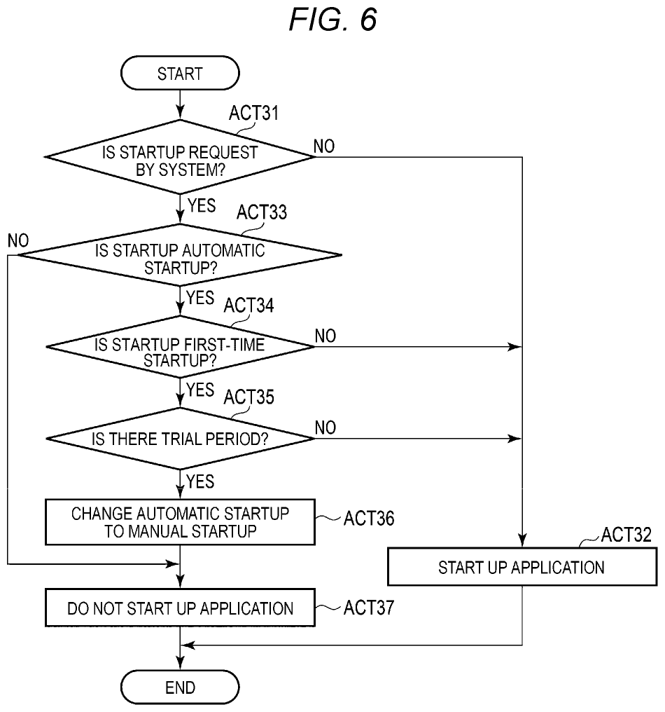

FIG. 6 is a flowchart illustrating an operation example of the startup check process for the application in the digital multifunction peripheral 1 as an information processing device according to the embodiment.

When the processor 21 receives the startup request of the application, the processor checks whether the startup request by the system or the startup request by the user operation (ACT31). For example, the processor 21 restarts up the digital multifunction peripheral 1 after installing the application during the normal startup after the unpacking setup. The processor 21 generates the startup request by the system when the digital multifunction peripheral 1 is restarted up. When the processor 21 receives the startup request by the user operation (ACT31, NO), the processor starts up the application designated by the user (ACT32).

When the processor 21 receives the startup request of the application (e.g., a startup request by the system, etc.) accompanying the startup of the digital multifunction peripheral 1 (ACT31, YES), the processor 21 proceeds to ACT33. That is, when the startup request by the system is generated, the processor 21 checks whether the startup method of the application is the automatic startup or the manual startup (ACT33). When the startup method of the application is the manual startup (ACT33, NO), the processor 21 does not start up the application (ACT37) because the application must not be started according to the startup request by the system.

When the startup method of the application is the automatic startup (ACT33, YES), the processor 21 determines whether or not the startup of the application is the first-time startup (first-time startup is not yet performed) (ACT34). For example, the processor 21 determines whether or not the first-time startup is not yet performed or is already performed, based on the management information of the application that receives the startup request.

It is noted that the digital multifunction peripheral 1 may be installed with an application group that realizes one function by combining a plurality of different types of applications. For example, the types of applications include an application with a UI (user interface), a resident application, and an application for administrator settings. For the application group, information indicating the applications to be combined may be indicated in the management information of each application.

For the application group that realizes one function by combining the plurality of applications, the number of startup is checked for the entire application. For example, when the first application is in a state where the first-time startup is finished, it is determined that the first-time startup of the second application to be combined with the first application is completely performed.

When the first-time startup of the application is completely performed (ACT34, NO), the processor 21 starts up the application (ACT32). For an application in a state where the first-time startup is finished, the trial license is already issued even if the probational period is provided. For this reason, there is no need to suppress the startup of the application of which the first-time startup is finished even if the trial period is provided, and the second-time startup and later will be performed without any restriction.

When the first-time startup of the application is not yet performed (first-time startup is not performed) (ACT34, NO), the processor 21 determines whether or not the trial period is provided to the application (ACT35). For example, the processor 21 determines whether or not the application is provided with the probational period based on the management information of the application. When the application is not provided with the trial period (ACT35, NO), the processor 21 starts up the application (ACT32).

When the trial period is provided to the application (ACT35, YES), the processor 21 changes the startup method in the management information of the application to the manual startup (ACT36). That is, the processor 21 updates the startup method from the automatic startup to the manual startup in the management information of the application.

However, the processor 21 may return the startup method of the application of which startup method was changed to the manual startup in the startup check process back to the automatic startup after the first startup. For example, the processor 21 may add information indicating that the startup method will be changed (e.g., returned to an original, switched, etc.) to the automatic startup after the first-time startup to the management information of the application that was changed to the automatic startup in the startup check process.

According to the startup check process as described above, the digital multifunction peripheral as an information processing device can stop the first-time automatic startup of the trial application. Further, the digital multifunction peripheral can change the startup method from the automatic startup to the manual startup when the first-time startup of the trial application is not yet performed. Accordingly, the digital multifunction peripheral can manage the startup method of the application of which first-time automatic startup is stopped as the manual startup.

It is noted that the startup check process as described above is not limited to being performed when the application bundled in the firmware is started up after installation. For example, the startup check process as described above may be performed in other startup process (for example, restarting up the digital multifunction peripheral 1).

Next, the startup operation of the application in the digital multifunction peripheral 1 as an information processing device according to the embodiment will be described.

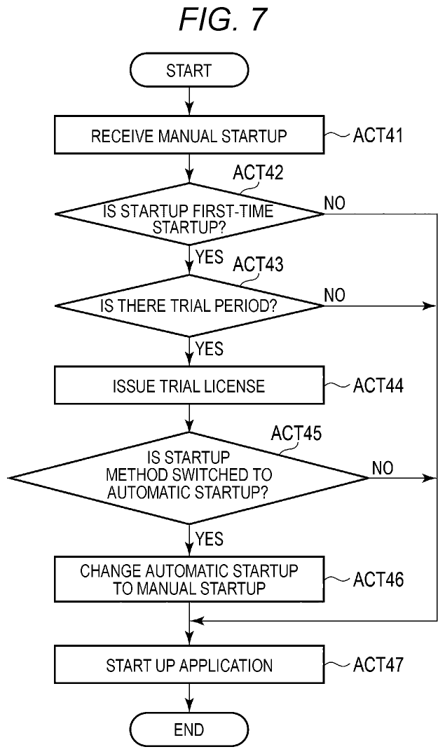

FIG. 7 is a flowchart illustrating an operation example of an application startup process by the manual startup in the digital multifunction peripheral 1 as an information processing device according to the embodiment.

It is assumed that the processor 21 received the startup request (e.g., the manual startup, etc.) by the user operation (ACT41). For example, the processor 21 accepts the startup request of the designated application input by the user using the input device 12.

When the processor 21 receives the startup request by the user operation, it determines whether or not the startup of the application designated by the user is the first-time startup (e.g., whether the first-time startup is not yet performed, etc.) (ACT42). For example, the processor 21 determines whether the first-time startup is not performed or is performed, based on the management information of the application of which the startup request is received.

In a state where the first-time startup of the application designated by the user is finished (ACT42, NO), the processor 21 starts up the application (ACT47).

When the first-time startup of the application designated by the user is not performed (e.g., the first-time startup is not yet performed, etc.) (ACT42, NO), the processor 21 determines whether or not the trial period is provided to the application (ACT43). When the trial period is not provided to the application (ACT43, NO), the processor 21 starts up the application (ACT47).

When the trial period is provided to the application designated by the user (ACT43, YES), the processor 21 issues the trial license for the application (ACT44). The trial license is a license that permits use of the application within the period setup in advance (e.g., trial period, probational period, etc.) from the current time of first-time startup. For example, the processor 21 starts counting down the remaining period that becomes a trial period from the time the trial license is issued as management information of the application.

After issuing the trial license, the processor 21 determines whether or not the startup method of the application needs be switched to the automatic startup (ACT45). For example, it is assumed that, in the management information of the application that is changed from the automatic startup to the manual startup in the startup check process, it is recorded that the startup method will be returned to the automatic startup after the first-time startup. In this case, the processor 21 determines whether or not information indicating that the startup method is to be returned to the automatic startup after the first-time startup is recorded in the management information of the application.

When the processor 21 determines that there is no need to switch to the automatic startup (ACT45, NO), the processor 21 starts up the application without changing the startup method (ACT47).

Further, when determining that the application needs to be switched to the automatic startup (ACT45, YES), the processor 21 changes the startup method of the application to the automatic startup (ACT47). The processor 21 updates the startup method from the manual startup to the automatic startup in the management information of the application. After changing the startup method of the application to the automatic startup, the processor 21 starts the application (ACT47).

According to the above-described manual startup process by the user operation, the digital multifunction peripheral 1 as an information processing device can issue the trial license for the application with the first-time startup. Further, the digital multifunction peripheral 1 can return the startup method of the application of which the startup method is changed from the automatic startup to the manual startup at the time of installation to the automatic startup after the first-time startup. As a result, the digital multifunction peripheral 1 can automatically start up, after the first-time startup, the application that is stopped from the automatic startup at the first-time startup.

As described above, the digital multifunction peripheral as an information processing device according to the embodiment can suppress the automatic startup of the application provided with the trial period in which the first-time startup is not performed. Accordingly, the digital multifunction peripheral can prevent the trial license from being issued with the automatic startup by restart up or the like after installing the application. Furthermore, the digital multifunction peripheral can issue the trial license in response to the startup instruction of the application specified by the user. As a result, in the digital multifunction peripheral, the trial license is not issued before the user uses the digital multifunction peripheral, and the probational period can be prevented from being shortened regardless of the user intention.

Furthermore, the digital multifunction peripheral as an information processing device according to the embodiment can change the startup method of the application provided with the trial period from the automatic startup to the manual startup. Accordingly, the digital multifunction peripheral can manage the application by not only stopping the first-time automatic startup but also changing the startup method of the application to the manual startup. As a result, the user can also confirm, through the user interface or the like, that the startup method of the trial application is changed to the manual startup.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a storage configured to store an application program provided with a probational period; and
a processor configured to stop a first-time automatic startup of the application program provided with the probational period during a startup of the information processing device.

2. The device according to claim 1,
wherein the storage is configured to store management information including information indicating if a first-time startup of the application program has been performed, and
wherein the processor is configured to stop an automatic startup of the application program if the first-time startup of the application program is not performed according to the management information.

3. The device according to claim 2,
wherein the management information includes information indicating a startup method of the application program, the startup method being at least one of an automatic startup that occurs during the startup of the information processing device or a manual startup that occurs in response to a user operation, and
wherein, when the information processing device is started up, the processor is configured to update the startup method in the management information of the application program to be the manual startup if the first-time startup has not been performed.

4. The device according to claim 3,
further comprising a system memory configured to store a data file for installing the application program along with firmware,
wherein the processor is configured to install the application program in the storage based on the data file stored together with the firmware in the system memory.

5. An image forming device comprising:
a printer that forms an image on a medium, comprising:
a storage configured to store an application program provided with a probational period; and
a controller comprising a processor configured to stop a first-time automatic startup of the application program provided with the probational period during a startup of the image forming device.

6. The image forming device of claim 5, further comprising:
an input device configured to receive an input operation and provide an input instruction based on the input operation to the controller; and
a display device configured to receive the input instruction from the controller.

7. The image forming device of claim 5, further comprising:
a scanner configured to scan a document placed on a document table of the printer and acquires an image of the document.

8. The image forming device of claim 5, wherein the storage is configured to store a plurality of application programs, and the storage is further configured to store management information for each of a plurality of application programs.

9. The image forming device of claim 8, wherein the management information comprises a startup method, an indication of if a first-time startup has occurred, and presence of a trial period.

10. The image forming device of claim 9, wherein when the trial period is present, the processor is configured to change the startup method from automatic startup to manual startup.

11. A method of operating an image forming device, the method comprising:
receiving a startup request of an application;
determining if a startup method of the application is an automatic startup;
in response to the startup method being automatic startup, determine if a first-time startup of the application has occurred; and
in response to the first-time startup having occurred, determine if the application includes a trial period.

12. The method of claim 11, further comprising:
in response to the application including the trial period, changing the startup method from automatic startup to manual startup; and
suppressing startup of the application.

13. The method of claim 11, wherein in response to determining that the first-time startup has not occurred, start the application.

14. The method of claim 11, wherein in response to the startup method of the application being set to manual startup, suppressing startup of the application.

15. The method of claim 11, wherein the startup request is provided by a user, and the startup method is a manual startup.

16. The method of claim 15, further comprising:
in response to the startup method being set to manual startup, determining if the startup is a first-time startup; and
in response to the startup being the first-time startup, and the application includes the trial period, issuing a trial license.

17. The method of claim 16, further comprising:
if response to the startup method being switched to automatic, changing the startup method to manual; and
starting the application.

18. The method claim 11, further comprising, prior to receiving the startup request, installing firmware bundled with the application, and turning on a packing mode indicating the image forming apparatus is in a state for normal startup.

19. The method of claim 18, wherein the startup request comprises:
receiving the startup request from a user to start the image forming apparatus
in response to an unpacking flag being set to on, determining if a built-in application to be installed is stored on the image forming apparatus;
in response to the built-in application to be installed being stored on the image forming apparatus, installing the application;
checking a startup mode of the application; and
restarting the image forming apparatus.

20. The method of claim 11, further comprising storing management information of the application including a startup method, an indication of if a first-time startup has occurred, and a presence of the trial period.
